(19) United States
(12) Patent Application Publication
(10) Pub. No.: US 2022/0392358 A1
(43) Pub. Date: Dec. 8, 2022

(54) METHOD AND APPARATUS FOR IMPLEMENTING AN AUTONOMOUS DISTRESS TRACKING TRIGGERING FUNCTION

(71) Applicant: HONEYWELL INTERNATIONAL INC., Charlotte, NC (US)

(72) Inventors: Harisha Bangalore Manjunath, Bangalore (IN); Rushoth Kumar M C, Bangalore (IN); Venu Puttam, Hyderabad (IN); Murali Kadeppagari, Bangalore (IN); Prashant Hegde, Bangalore (IN); Chandana Venigalla, Bangalore (IN); Supratik Gon, Bangalore (IN); Brad H. Miller, Redmond, WA (US); Gary Ostrom, Redmond, WA (US); Ricardo Darif Bortolini, Phoenix, AZ (US); Dhivagar Palanisamy, Phoenix, AZ (US); David Kolbet, Phoenix, AZ (US); John Vo, Phoenix, AZ (US)

(73) Assignee: HONEYWELL INTERNATIONAL INC., Charlotte, NC (US)

(21) Appl. No.: 17/443,288

(22) Filed: Jul. 23, 2021

(30) Foreign Application Priority Data
Jun. 8, 2021 (IN) 202111025424

(51) Int. Cl. G08G 5/00; B64D 45/00

(52) U.S. Cl. CPC G08G 5/0056; G08G 5/0073; G08G 5/0013; B64D 45/00; B64D 2045/0065

(57) ABSTRACT

A system and method for implementing an autonomous distress tracking (ADT) triggering function is provided. The method comprises receiving a configuration file containing a plurality of user configurable parameters from a ground-based system, configuring an aircraft condition and monitoring function (ACMF) engine to apply trigger logic specified by the plurality of user configurable parameters to aircraft sensor and/or system data and monitoring for a plurality of distress conditions specified by the plurality of user configurable parameters; executing the configured ACMF engine to detect the occurrence of a distress condition; automatically generating a data message when a distress condition occurrence has been detected wherein the data message can include aircraft position data specified in the user configurable parameters, the aircraft sensor and/or system data on which the detection of the one or more trigger conditions was based, and the identity of the detected distress condition; and automatically sending the data message to a transmission system onboard the aircraft that is configured to transmit a search and rescue signal.

### CROSS REFERENCE TO RELATED APPLICATION

The present application claims benefit of prior filed Indian Provisional Patent Application No. 202111025424, filed Jun. 8, 2021, which is hereby incorporated by reference herein in its entirety.

### TECHNICAL FIELD

Embodiments of the subject matter described herein relate generally to autonomous distress tracking (ADT). More particularly, embodiments of the subject matter relate to systems and methods for providing user configurable ADT on an aircraft.

### BACKGROUND

Autonomous distress tracking (ADT) has been mandated for commercial aircraft as part of the Global Aeronautical Distress and Safety System (GADSS) initiative launched by the International Civil Aviation Organization (ICAO) after several accidents where downed aircraft could not be located at all, or only after long and expensive search efforts. Adding additional equipment onto an aircraft can be an expensive endeavor in terms of cost and time due to hardware and software certification requirements. Also, adding hardware can increase the weight of the aircraft and require hardwiring to the airplane data network, sensors, and systems. Implementing an ADT triggering function with new hardware can be costly due to, among other things, hardware certification and hardware infrastructure and wiring changes required to interface with the onboard aircraft sensors and avionics systems for aircraft state determination and distress data transmission.

Hence, it is desirable to provide systems and methods for implementing an ADT triggering function without adding additional hardware. Furthermore, other desirable features and characteristics of the present invention will become apparent from the subsequent detailed description and the appended claims, taken in conjunction with the accompanying drawings and the foregoing technical field and background.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an autonomous distress tracking (ADT) triggering function implemented in an aircraft is disclosed. The ADT triggering function includes a controller configured to receive a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The controller is further configured to configure an aircraft condition and monitoring function (ACMF) engine using the plurality of user configurable parameters from the ground-based system to apply the trigger logic to the identified aircraft sensor and/or system data and monitor for the plurality of distress conditions specified by the plurality of user configurable parameters; execute the configured ACMF engine to detect the occurrence of a distress condition specified in the plurality of user configurable parameters; automatically generate a data message when a distress condition occurrence has been detected, wherein the data message includes the aircraft sensor and/or system data on which the detection of the one or more trigger conditions was based and the identity of the detected distress condition; and automatically send the data message to a transmission system onboard the aircraft that is configured to transmit a search and rescue signal, wherein ADT functionality that is user configurable is provided on the aircraft.

In another embodiment, a computer-implemented method in an aircraft for implementing an autonomous distress tracking (ADT) triggering function is disclosed. The method includes receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further includes: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

In another embodiment, disclosed is a non-transitory computer-readable medium having stored thereon instructions that when executed by a processor on an aircraft cause the processor to perform a method for implementing an autonomous distress tracking (ADT) triggering function. The method includes receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further includes: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

Furthermore, other desirable features and characteristics will become apparent from the subsequent detailed description and the appended claims, taken in conjunction with the accompanying drawings and the preceding background.

### BRIEF DESCRIPTION OF THE DRAWINGS

Embodiments of the subject matter will hereinafter be described in conjunction with the following drawing figures, wherein like numerals denote like elements, and wherein:

FIG. 1 is a block diagram depicting an example environment associated with an aerial vehicle that implements an autonomous distress tracking (ADT) triggering function, in accordance with some embodiments;

FIG. 2 is a block diagram depicting another example environment associated with an aerial vehicle that implements an autonomous distress tracking (ADT) triggering function, in accordance with some embodiments; and

FIG. 3 is a process flow chart depicting an example process 300 for implementing an autonomous distress tracking triggering function, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical components and various processing steps. It should be appreciated that such functional and/or logical components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for implementing an autonomous distress tracking (ADT) triggering function using on-board systems that can detect an emergency and broadcast position, or distinctive distress signals from which aircraft position can be derived. The ICAO has updated ICAO Annex 6 standards to include requirements for tracking commercial planes during all phases of flight. ARINC project paper 680 highlights the objectives and requirements as defined by the ICAO for including functionality for autonomous identification and reporting of distress situations using ADT in addition to Aircraft Tracking (AT) and Post Flight Localization & Recovery (PFLR). The apparatus, systems, techniques, and articles provided herein can provide an operator of an airplane flexibility in how an ADT triggering function is implemented while still satisfying ADT mandated objectives.

The apparatus, systems, techniques, and articles provided herein utilizes hardware already existing on the aircraft that has sufficient CPU processing capability to host the ADT functionality and that can be certified to DO178 B/C DAL-C assurance level. The apparatus, systems, techniques, and articles provided herein can utilize hardware already existing on the aircraft that have input/output channels available to interface with aircraft sensors and systems onboard the aircraft. The apparatus, systems, techniques, and articles provided herein can utilize hardware already existing on the aircraft that have input/output channels available to interface with air to ground datalink channels to allow aircraft state and data to be transmitted to ground infrastructure.

The apparatus, systems, techniques, and articles provided herein can utilize common software components that are common amongst different types of aircraft and that can be customized by an aircraft operator via user-selectable parameters for use on different types of aircraft. Customizing ADT software from scratch for different aircraft types can lead to high development, verification, and certification costs, whereas the reuse of common software components can minimize the development, verification, and certification costs.

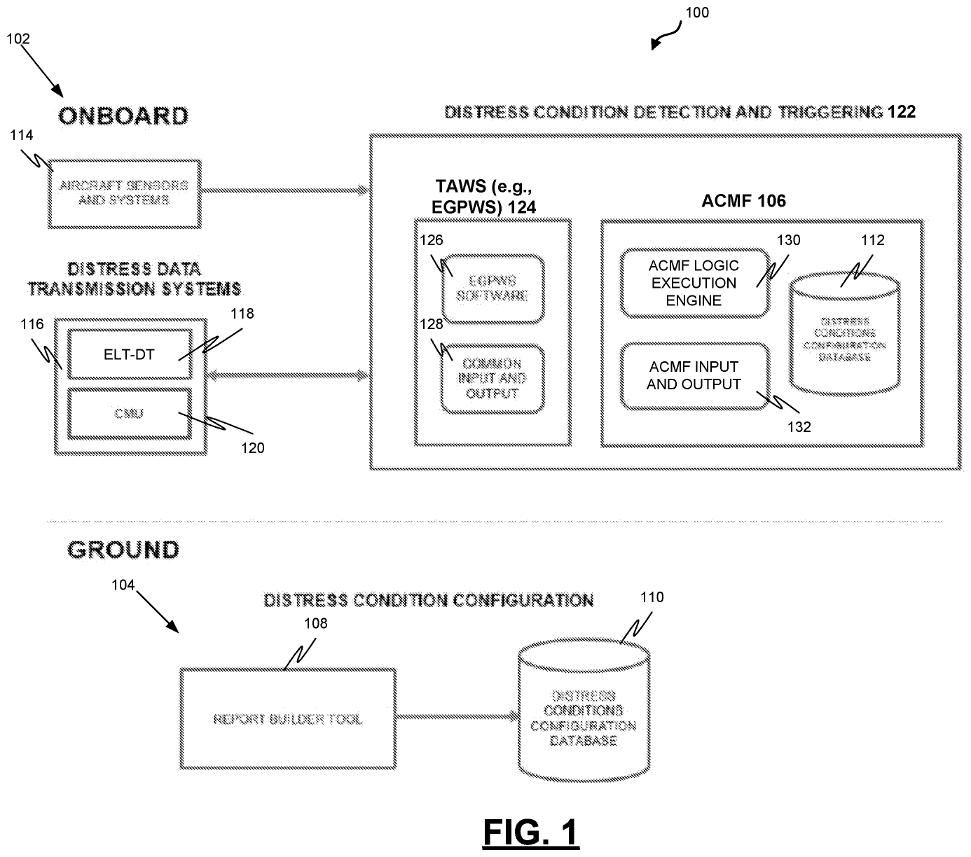

FIG. 1 is a block diagram depicting an example environment 100 associated with an aerial vehicle (e.g., manned aircraft, unmanned aircraft, fixed wing, roto craft, UAV, or other aircraft) that implements an autonomous distress tracking (ADT) triggering function. The example environment 100 includes onboard aircraft equipment 102 and ground equipment 104, and implements an aircraft condition monitoring system (ACMS) that comprises an onboard aircraft condition monitoring function (ACMF) 106 implemented by the onboard aircraft equipment 102 and a corresponding ground-based Report Builder (RB) tool 108 implemented by the ground equipment 104.

The example Report Builder tool 108, implemented by the ground equipment 104 (e.g., desktop computer), is configured to generate one or more custom configuration files (e.g., called ACMF applications Field Loadable Logic File) for a distress conditions configuration database 110. The sets of instructions from one or more custom configuration files in the distress conditions configuration database 110 are subsequently delivered to the ACMF 106 and stored in an onboard distress conditions configuration database 112. These instructions convey to the ACMF 106 which aircraft parameters to monitor, which trigger conditions to evaluate, which conditions should trigger the ACMF 106 to generate a distress signal or report, and which parameters to be included in a report, etc.

The ACMF 106 is the airborne component of the ACMS. The ACMF 106 collects user-specified parameters specified in the instructions in the custom configuration files and evaluates conditions based on user-specified conditions specified in the instructions in the custom configuration files. When the user-specified conditions are met, the ACMF 106 generates a distress signal for transmission to a distress data transmission system 116 such as ELT-DT 118 and/or reports containing time-sampled data from an aircraft bus, and/or computed values that are derived from that time-sampled data.

A user (e.g., Aircraft Operator or Original Equipment Manufacturer) can configure the conditions to be evaluated, parameters to be collected including its rate of collection, format, etc. and build the loadable database 110. The database 110 can be loaded on-board the aircraft into the onboard distress conditions configuration database 112 where the ACMF 106 can evaluate the conditions specified in the onboard distress conditions configuration database 112 and collect report data specified in the onboard distress conditions configuration database 112 based on trigger conditions specified in the onboard distress conditions configuration database 112. The collected reports can be stored in the available/configured storage devices and or can be transmitted through communication links as needed/configured in the onboard distress conditions configuration database 112. The collected data can be used for post flight analysis to support airplane maintenance, performance, troubleshooting, and trend monitoring.

The example onboard aircraft equipment 102 also includes aircraft sensors and systems 114 (e.g., Flight Control System (FCS), Engine Control Unit (ECU), Inertial Reference System (IRS)), one or more distress data transmission systems 116 such as an emergency locator transmitter-Distress Tracker (ELT-DT) 118 and/or a communications management unit (CMU) 120, and a distress condition detection and triggering system 122. The example distress condition detection and triggering system 122 includes processing components for implementing a terrain awareness and warning system (TAWS) 124, such as an enhanced ground proximity warning system (EGPWS). The processing components in the example distress condition detection and triggering system 122 are also used to implement the ACMF 106.

The processing components (e.g., controllers) in the example distress condition detection and triggering system 122 (and 222) include at least one processor and a computer-readable storage device or media encoded with programming instructions for configuring the processing component. The processor may be any custom-made or commercially available processor, a central processing unit (CPU), a graphics processing unit (GPU), an application specific integrated circuit (ASIC), a field programmable gate array (FPGA), an auxiliary processor among several processors associated with the processing component, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the processing component.

The example TAWS 124 includes software 126 (e.g., GPWS or EGPWS software) for alerting flight crew members (e.g., pilots) if their aircraft is in immediate danger of flying into the ground or an obstacle. To perform its alerting function the TAWS 124 includes common input and output 128 for interfacing with aircraft sensors and systems 114, and distress data transmission systems 116 such as an emergency locator transmitter-Distress Tracker (ELT-DT) 118 and/or a communications management unit (CMU) 120. The common input and output 128 can be made available to the ACMF 106 for use when collecting user-specified parameters specified in the instructions in the custom configuration files, evaluating conditions based on user-specified conditions specified in the instructions in the custom configuration files, and collecting report data specified in the instructions in the custom configuration files including time-sampled data from an aircraft bus and/or computed values that are derived from that time-sampled data.

The example ACMF 106 includes an ACMF logic execution engine 130 comprising software that is configured by the plurality of instructions contained in the custom configuration files in the distress conditioning configuration database 112 and an ACMF input and output section 132 for interfacing with aircraft sensors and systems 114, and distress data transmission systems 116 such as an emergency locator transmitter-Distress Tracker (ELT-DT) 118 and/or a communications management unit (CMU) 120, via the common input and output 128.

In this example, the ACMF 106 provides an ADT triggering function implemented in a terrain TAWS 122 on an aircraft. The ADT triggering function comprises processing components (e.g., a controller) configured to receive a configuration file containing a plurality of user configurable parameters from a ground-based system 104 that: identify a plurality of distress conditions for which to monitor, identify aircraft sensor and/or system data (e.g., from aircraft sensors and systems 114) from which the distress conditions can be determined, provide trigger logic for each distress condition wherein the trigger logic for each distress condition identifies logic to apply to the aircraft sensor and/or system data and one or more trigger conditions (e.g., Unusual Altitude, Unusual Speed, Loss of Thrust/Power, Collision with Terrain) for identifying the occurrence of the distress condition (e.g., Engine failure in flight, Loss of control In-flight, Controlled Flight into Terrain, Failure of Onboard Communication system/Failure to report airplane position or operational status), and identify aircraft position data from which an aircraft position can be derived during the occurrence of a distress condition.

The processing components are further configured to execute an ACMF engine that is configured by the plurality of user configurable parameters from the ground-based system to apply the trigger logic to the identified aircraft sensor and/or system data and monitor for the plurality of distress conditions specified by the plurality of user configurable parameters, and execute the configured ACMF engine to detect the occurrence of a distress condition specified in the plurality of user configurable parameters. The processing components are further configured to automatically generate a data message when a distress condition occurrence has been detected wherein the data message can include aircraft position data specified in the user configurable parameters, the aircraft sensor and/or system data on which the detection of the one or more trigger conditions was based, and the identity of the detected distress condition. The processing components are further configured to automatically send the data message to a ground center via the distress data transmission systems 116 such as an emergency locator transmitter-Distress Tracker (ELT-DT) 118 and/or a communications management unit (CMU) 120, via the common input and output 128. Thus, ADT functionality that is user configurable is provided on the aircraft.

To reduce the number of nuisance alerts, a “Power Valid” discrete signal (e.g., on/off signal) indicating that the power is valid to the TAWS 124 may be provided from the TAWS 124 to a distress data transmission system 116 (e.g., ELT-DT 118 and/or CMU 120). The Power Valid signal may be used as a supplemental triggering signal that informs the distress data transmission system 116 of the power state of the TAWS 124. This may allow a single instance of an ACMF 106 generated distress signal, when a Power Valid signal is active, to trigger the distress data transmission system 116 and meet desired nuisance alert rates. Alternatively or additionally, two instances (within a specified time period) of an ACMF 106 generated distress signal (with or without an active Power Valid signal) may be used to trigger the distress data transmission system 116 and meet desired nuisance alert rates.

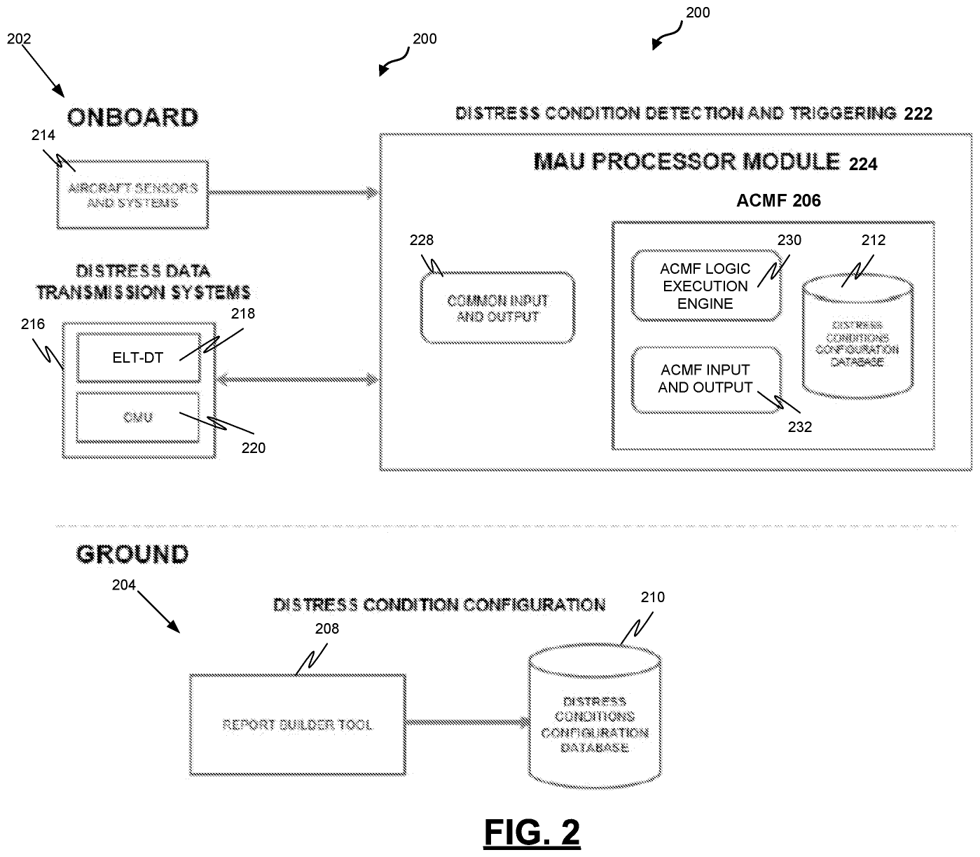

FIG. 2 is a block diagram depicting an example environment 200 associated with an aerial vehicle (e.g., manned aircraft, unmanned aircraft, UAV, or other aircraft) that implements an autonomous distress tracking (ADT) triggering function. The example environment 200 includes onboard aircraft equipment 202 and ground equipment 204, and implements an aircraft condition monitoring system (ACMS) that comprises an onboard aircraft condition monitoring function (ACMF) 206 implemented by the onboard aircraft equipment 202 and a corresponding ground-based Report Builder (RB) tool 208 implemented by the ground equipment 204.

The example report builder tool 208, implemented by the ground equipment 204 (e.g., desktop computer), is configured to generate one or more custom configuration files (e.g., called ACMF applications Field Loadable Logic File) for a distress conditions configuration database 210. The sets of instructions from one or more custom configuration files in the distress conditions configuration database 210 are subsequently delivered to the ACMF 206 and stored in an onboard distress conditions configuration database 212. These instructions tell the ACMF 206 which aircraft parameters to monitor, which trigger conditions to evaluate, which conditions should trigger the ACMF 206 to generate a distress signal or a report, and which parameters to be included in a report, etc.

The ACMF 206 is the airborne component of the ACMS. The ACMF 206 collects user-specified parameters specified in the instructions in the custom configuration files and evaluates conditions based on user-specified conditions specified in the instructions in the custom configuration files. When the user-specified conditions are met, the ACMF 206 generates a distress signal for transmission to a distress data transmission system 116 such as ELT-DT 218 and/or reports containing time-sampled data from an aircraft bus, and/or computed values that are derived from that time-sampled data.

A user (e.g., Aircraft Operator or Original Equipment Manufacturer) can configure the conditions to be evaluated, parameters to be collected including its rate of collection, format, etc. and build the loadable database 210. The database 210 can be loaded on-board the aircraft into the onboard distress conditions configuration database 212 where the ACMF 206 can evaluate the conditions specified in the onboard distress conditions configuration database 212 and collect report data specified in the onboard distress conditions configuration database 212 based on trigger conditions specified in the onboard distress conditions configuration database 212. The collected reports can be stored in the available/configured storage devices and or can be transmitted through communication links as needed/configured in the onboard distress conditions configuration database 212. The collected data can be used for post flight analysis to support airplane maintenance, performance, troubleshooting, and trend monitoring.

The example onboard aircraft equipment 202 also includes aircraft sensors and systems 214 (e.g., Flight Control System (FCS), Engine Control Unit (ECU), Inertial Reference System (IRS)), one or more distress data transmission systems 216 such as an emergency locator transmitter-Distress Tracker (ELT-DT) 218 and/or a communications management unit (CMU) 220, and a distress condition detection and triggering system 222. The example distress condition detection and triggering system 222 comprises processing components included in a modular avionics unit (MAU) processor module 224. The processing components in the MAU processor module 224 are used to implement the ACMF 206.

The MAU processor module 224 is a module that is incorporated in a hardware cabinet called the modular avionics unit (MAU). The MAU blends aircraft-wide network capabilities connected via a high-speed data bus (e.g., ASCB data bus) with a cabinet-based modular architecture. Field removable modules (such as the MAU processor module 224) for computing, database storage, input/output, network communication, and/or power supply are plugged into the MAU.

The example MAU processor module 224 includes common input and output 228 for interfacing with aircraft sensors and systems 214, and distress data transmission systems 216 such as an emergency locator transmitter-Distress Tracker (ELT-DT) 218 and/or a communications management unit (CMU) 220. The common input and output 228 can be made available to the ACMF 206 for use when collecting user-specified parameters specified in the instructions in the custom configuration files, evaluating conditions based on user-specified conditions specified in the instructions in the custom configuration files, and collecting report data specified in the instructions in the custom configuration files including time-sampled data from an aircraft bus and/or computed values that are derived from that time-sampled data.

The example ACMF 206 includes an ACMF logic execution engine 230 comprising software for executing an ACMF engine using the plurality of instructions contained in the custom configuration files in the distress conditioning configuration database 212 and an ACMF input and output section 232 for interfacing with aircraft sensors and systems 214, and distress data transmission systems 216 such as an emergency locator transmitter-Distress Tracker (ELT-DT) 218 and/or a communications management unit (CMU) 220, via the common input and output 228.

In this example, the ACMF 206 provides an ADT triggering function implemented on a MAU processor module 224 on an aircraft. The ADT triggering function comprises processing components (e.g., a controller) configured to receive a configuration file containing a plurality of user configurable parameters from a ground-based system 204 that: identify a plurality of distress conditions for which to monitor, identify aircraft sensor and/or system data (e.g., from aircraft sensors and systems 214) from which the distress conditions can be determined, provide trigger logic for each distress condition wherein the trigger logic for each distress condition identifies logic to apply to the aircraft sensor and/or system data and one or more trigger conditions (e.g., Unusual Altitude, Unusual Speed, Loss of Thrust/Power, Collision with Terrain) for identifying the occurrence of the distress condition (e.g., Engine failure in flight, Loss of control In-flight, Controlled Flight into Terrain, Failure of Onboard Communication system/Failure to report airplane position or operational status), and identify aircraft position data from which an aircraft position can be derived during the occurrence of a distress condition.

The processing components are further configured to execute the ACMF engine that is configured by the plurality of user configurable parameters from the ground-based system to apply the trigger logic to the identified aircraft sensor and/or system data and monitor for the plurality of distress conditions specified by the plurality of user configurable parameters, and execute the configured ACMF engine to detect the occurrence of a distress condition specified in the plurality of user configurable parameters. The processing components are further configured to automatically generate a data message when a distress condition occurrence has been detected wherein the data message can include aircraft position data specified in the user configurable parameters, the aircraft sensor and/or system data on which the detection of the one or more trigger conditions was based, and the identity of the detected distress condition. The processing components are further configured to automatically send the data message to a ground center via the distress data transmission systems 216 such as an emergency locator transmitter-Distress Tracker (ELT-DT) 218 and/or a communications management unit (CMU) 220, via the common input and output 228. Thus, ADT functionality that is user configurable is provided on the aircraft. To reduce the number of nuisance alerts, in some examples, two instances (within a specified time period) of an ACMF 206 generated distress signal may be used to trigger the distress data transmission system 216 and meet desired nuisance alert rates.

The example ACMS can comply with all conditions needed to implement an ADT system. First, the example ACMS provides Distress Condition Configuration capabilities. The example ACMS provides ground tools (e.g., Report Builder tool 108/208) for an ADT system to configure parameters, distress conditions/trigger logic and aircraft position parameters for transmission including the rate of transmission using transmission systems such as CMU, ELT-DT, or SATCOM.

An example Report Builder (RB) tool (108/208) provides a User Interface tool with simple modelling interface, where-in a user is provided with a rich set of toolboxes containing mathematical function models. Example mathematical functions provided include Arithmetic, Statistical, Logical, Relational, Assignment, Changed State, signal time and frequency transformation. Triggers may be configured to be executed at any of the following typical avionics interval (e.g., 20 Hz, 10 Hz, 5 Hz, 1 Hz). The output of the RB tool (108/208) will be provided to a Distress Conditions Configuration Database (DCCD) 210 in a format such as Structured Query Language (SQL), Extensible Markup Language (XML), JavaScript Object Notation (JSON), or binary format.

Second, the example ACMS provides Distress Condition Detection and Triggering. The example ACMS provides onboard software components (e.g., ACMF logic execution engine 130/230) that operate based on user configured parameters. The software continuously collects configured parameters, evaluated trigger conditions, and identifies distress conditions.

The example ACMF Logic Execution Engine (130/230) performs the ADT functionality by reading the DCCD database (112/212), processing and executing the defined triggers, and transmitting the aircraft state and data via the ACMF Input and Output (I/O) blocks (132/232). The ACMF I/O blocks (132/232) represent functionality that is capable of performing airplane parameter I/O via the avionics available interfaces (128/228).

Third, the example ACMS provides Distress Data Transmission. The example ACMS provides a way to transmit distress data including aircraft positional information to ground data centers through various communication channels established in the respective airplane.

Fourth, the example ACMS provides access to Aircraft Systems and Sensors. The example ACMS provides access to aircraft systems and sensors that are the source of airplane parameters information that can be used for aircraft state or distress condition determination required to perform ADT functionality.

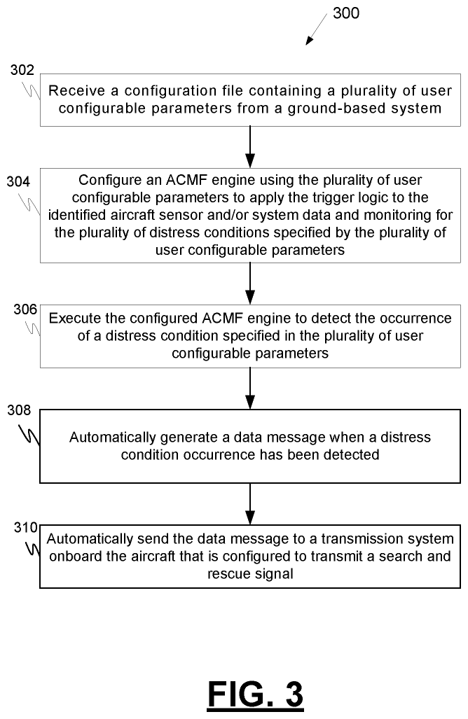

FIG. 3 is a process flow chart depicting an example process 300 for implementing autonomous distress tracking. The example process may be performed in a TAWS or a MAU processor module. The order of operation within the process 300 is not limited to the sequential execution as illustrated in the figure but may be performed in one or more varying orders as applicable and in accordance with the present disclosure.

The example process 300 includes receiving a configuration file containing a plurality of user configurable parameters from a ground-based system (operation 302). The user configurable parameters may identify a plurality of distress conditions for which to monitor, identify aircraft sensor and/or system data from which the distress conditions can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The ground-based system may comprise a software tool configured to build the configuration file containing the plurality of user configurable parameters and store the configuration file containing the plurality of user configurable parameters in a database.

The received configuration file may be subsequently stored in a database onboard the aircraft. The format of the configuration file may comprise Structured Query Language (SQL), Extensible Markup Language (XML), JavaScript Object Notation (JSON), or binary format.

The trigger logic may comprise one or more mathematical functions including one or more of arithmetic, statistical, logical, relational, assignment, changed state, signal time, or frequency transformation functions. The trigger logic may be configured to be executed at one or more of the following avionics intervals: 20 Hertz (Hz), 10 Hz, 5 Hz, or 1 Hz.

The example process 300 includes configuring an ACMF engine using the plurality of user configurable parameters to apply the trigger logic to the identified aircraft sensor and/or system data and monitoring for the plurality of distress conditions specified by the plurality of user configurable parameters (operation 304).

The example process 300 includes executing the configured ACMF engine to detect the occurrence of a distress condition specified in the plurality of user configurable parameters (operation 306). Executing the configured ACMF engine may comprises applying the trigger logic specified in the user configurable parameters to the aircraft sensor and/or system data specified in the user configurable parameters, and detecting the occurrence of a distress condition identified in the plurality of user configurable parameters when the occurrence of one or more of the trigger conditions specified in the user configurable parameters is detected.

The example process 300 includes automatically generating a data message when a distress condition occurrence has been detected (operation 308). The data message may include aircraft position data specified in the user configurable parameters, the aircraft sensor and/or system data on which the detection of the one or more trigger conditions was based, and the identity of the detected distress condition.

The example process 300 includes automatically sending the data message to a transmission system onboard the aircraft that is configured to transmit a search and rescue signal (operation 310). The user configurable parameters may comprise an identity of a transmission system onboard the aircraft to use to automatically transmit the search and rescue signal to a ground center, and automatically sending the data message may comprise automatically transmitting the search and rescue signal to the ground center using the transmission system specified in the user configurable parameters. The transmission system may comprise an onboard emergency locator transmitter-Distress Tracker (ELT-DT) or a communication management unit (CMU).

Described herein are apparatus, systems, techniques, and articles for implementing an autonomous distress tracking (ADT) triggering function using on-board systems that can detect an emergency and broadcast position, or distinctive distress signals from which aircraft position can be derived. The apparatus, systems, techniques and articles provided herein can eliminate the need for separate hardware to implement an ADT solution, eliminate separate hardware certification and cost, allow for reusing of ACMF software component stacks and configuration tools to speed up ADT development and deployment, provide a retrofit solution that can be deployed into an aircraft that hosts a TAWS or MAU processor module, provide a configuration and modelling tool that simplifies ADT distress condition configuration and destination transmission systems, and allow for additional ADT requirements (parameters or trigger scenarios, etc.) to be enforced in future through the use of the ground tool to configure parameters.

In one embodiment, an autonomous distress tracking (ADT) triggering function implemented in a terrain awareness and warning system (TAWS) on an aircraft is provided. The system comprises a controller configured to receive a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The controller is further configured to configure an aircraft condition and monitoring function (ACMF) engine using the plurality of user configurable parameters from the ground-based system to apply the trigger logic to the identified aircraft sensor and/or system data and monitor for the plurality of distress conditions specified by the plurality of user configurable parameters; execute the configured ACMF engine to detect the occurrence of a distress condition specified in the plurality of user configurable parameters; automatically generate a data message when a distress condition occurrence has been detected, wherein the data message includes the aircraft sensor and/or system data on which the detection of the one or more trigger conditions was based, and the identity of the detected distress condition; and automatically send the data message to a transmission system onboard the aircraft that is configured to transmit a search and rescue signal, wherein ADT functionality that is user configurable is provided on the aircraft.

These aspects and other embodiments may include one or more of the following features. The configuration file may be stored in a database onboard the aircraft. To execute the controller may be further configured to apply the trigger logic specified in the user configurable parameters to the aircraft sensor and/or system data specified in the user configurable parameters; and detect the occurrence of a distress condition identified in the plurality of user configurable parameters when the occurrence of one or more of the trigger conditions specified in the user configurable parameters is detected. ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and to automatically send the controller may be configured to automatically transmit the search and rescue signal to the ground center using the transmission system specified in the user configurable parameters. The transmission system may comprise an onboard emergency locator transmitter-Distress Tracker (ELT-DT) or a communication management unit (CMU).

In another embodiment, a computer-implemented method in a terrain awareness and warning system (TAWS) on an aircraft for implementing an autonomous distress tracking (ADT) triggering function is provided. The method comprises receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further comprises: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

These aspects and other embodiments include one or more of the following features. The executing the configured ACMF engine may comprise applying the trigger logic specified in the user configurable parameters to the aircraft sensor and/or system data specified in the user configurable parameters; and detecting the occurrence of a distress condition identified in the plurality of user configurable parameters when the occurrence of one or more of the trigger conditions specified in the user configurable parameters is detected. The method may further comprise storing the configuration file in a database onboard the aircraft. The ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and automatically sending the data message may comprise automatically transmitting the search and rescue signal to the ground center using the transmission system specified in the user configurable parameters. The transmission system may comprise an onboard emergency locator transmitter-Distress Tracker (ELT-DT) or a communication management unit (CMU).

In another embodiment, non-transitory computer-readable medium having stored thereon instructions that when executed by a processor in a terrain awareness and warning system (TAWS) on an aircraft cause the processor to perform a method for implementing an autonomous distress tracking (ADT) triggering function. The method comprises receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further comprises: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

These aspects and other embodiments include one or more of the following features. The executing the configured ACMF engine may comprise applying the trigger logic specified in the user configurable parameters to the aircraft sensor and/or system data specified in the user configurable parameters; and detecting the occurrence of a distress condition identified in the plurality of user configurable parameters when the occurrence of one or more of the trigger conditions specified in the user configurable parameters is detected. The method may further comprise storing the configuration file in a database onboard the aircraft. The ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and automatically sending the data message may comprise automatically transmitting the search and rescue signal to the ground center using the transmission system specified in the user configurable parameters. The transmission system may comprise an onboard emergency locator transmitter-Distress Tracker (ELT-DT) or a communication management unit (CMU).

In another embodiment, an autonomous distress tracking (ADT) triggering function implemented in a modular avionics unit (MAU) processor module on an aircraft is provided. The system comprises a controller configured to receive a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The controller is further configured to configure an aircraft condition and monitoring function (ACMF) engine using the plurality of user configurable parameters from the ground-based system to apply the trigger logic to the identified aircraft sensor and/or system data and monitor for the plurality of distress conditions specified by the plurality of user configurable parameters; execute the configured ACMF engine to detect the occurrence of a distress condition specified in the plurality of user configurable parameters; automatically generate a data message when a distress condition occurrence has been detected, wherein the data message includes the aircraft sensor and/or system data on which the detection of the one or more trigger conditions was based and the identity of the detected distress condition; and automatically send the data message to a transmission system onboard the aircraft that is configured to transmit a search and rescue signal, wherein ADT functionality that is user configurable is provided on the aircraft.

These aspects and other embodiments may include one or more of the following features. The configuration file may be stored in a database onboard the aircraft. To execute the controller may be further configured to apply the trigger logic specified in the user configurable parameters to the aircraft sensor and/or system data specified in the user configurable parameters; and detect the occurrence of a distress condition identified in the plurality of user configurable parameters when the occurrence of one or more of the trigger conditions specified in the user configurable parameters is detected. ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and to automatically send the controller may be configured to automatically transmit the search and rescue signal to the ground center using the transmission system specified in the user configurable parameters. The transmission system may comprise an onboard emergency locator transmitter-Distress Tracker (ELT-DT) or a communication management unit (CMU).

In another embodiment, a computer-implemented method in a modular avionics unit (MAU) processor module on an aircraft for implementing an autonomous distress tracking (ADT) triggering function is provided. The method comprises receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further comprises: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

These aspects and other embodiments include one or more of the following features. The executing the configured ACMF engine may comprise applying the trigger logic specified in the user configurable parameters to the aircraft sensor and/or system data specified in the user configurable parameters; and detecting the occurrence of a distress condition identified in the plurality of user configurable parameters when the occurrence of one or more of the trigger conditions specified in the user configurable parameters is detected. The method may further comprise storing the configuration file in a database onboard the aircraft. The ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and automatically sending the data message may comprise automatically transmitting the search and rescue signal to the ground center using the transmission system specified in the user configurable parameters. The transmission system may comprise an onboard emergency locator transmitter-Distress Tracker (ELT-DT) or a communication management unit (CMU).

In another embodiment, non-transitory computer-readable medium having stored thereon instructions that when executed by a processor in a modular avionics unit (MAU) processor module on an aircraft cause the processor to perform a method for implementing an autonomous distress tracking (ADT) triggering function. The method comprises receiving a configuration file containing a plurality of user configurable parameters from a ground-based system that: identify aircraft sensor and/or system data from which a plurality of distress conditions for which to monitor can be determined, provide trigger logic for each distress condition wherein the trigger logic for each distress condition identifies logic to apply to the aircraft sensor and/or system data and one or more trigger conditions for identifying the occurrence of the distress condition, and identify aircraft position data from which an aircraft position can be derived during the occurrence of a distress condition. The method further comprises: configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters; executing the configured ACMF engine to detect the occurrence of a distress condition specified in the plurality of user configurable parameters; automatically generating a data message when a distress condition occurrence has been detected wherein the data message includes the aircraft sensor and/or system data on which the detection of the one or more trigger conditions was based and the identity of the detected distress condition; and automatically sending the data message to a transmission system onboard the aircraft that is configured to transmit a search and rescue signal, wherein ADT functionality that is user configurable is provided on the aircraft.

These aspects and other embodiments include one or more of the following features. The executing the configured ACMF engine may comprise applying the trigger logic specified in the user configurable parameters to the aircraft sensor and/or system data specified in the user configurable parameters; and detecting the occurrence of a distress condition identified in the plurality of user configurable parameters when the occurrence of one or more of the trigger conditions specified in the user configurable parameters is detected. The method may further comprise storing the configuration file in a database onboard the aircraft. The ADT functionality that is user configurable may be provided on the aircraft without additional hardware being added to the aircraft. The ground-based system may comprise a software tool configured to build the configuration file containing the plurality of user configurable parameters and store the configuration file containing the plurality of user configurable parameters in a database. The trigger logic may comprise one or more mathematical functions including one or more of arithmetic, statistical, logical, relational, assignment, changed state, signal time, or frequency transformation functions. The trigger logic may be configured to be executed at one or more of the following avionics intervals 20 Hertz (Hz), 10 Hz, 5 Hz, or 1 Hz. The format of the configuration file may comprise Structured Query Language (SQL), Extensible Markup Language (XML), JavaScript Object Notation (JSON), or binary format. The user configurable parameters may further comprise an identity of a transmission system onboard the aircraft that is configured to transmit the search and rescue signal to a ground center, and automatically sending the data message may comprise automatically transmitting the search and rescue signal to the ground center using the transmission system specified in the user configurable parameters. The transmission system may comprise an onboard emergency locator transmitter-Distress Tracker (ELT-DT) or a communication management unit (CMU).

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in software executed by a processor, or in a combination of the two. A software may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An autonomous distress tracking (ADT) triggering function implemented in a terrain awareness and warning system (TAWS) on an aircraft, the ADT triggering function comprising a controller configured to:
receive a configuration file containing a plurality of user configurable parameters from a ground-based system that:
identify aircraft sensor and/or system data from which a plurality of distress conditions for which to monitor can be determined,
provide trigger logic for each distress condition, the trigger logic for each distress condition identifying logic to apply to the aircraft sensor and/or system data and one or more trigger conditions for identifying the occurrence of the distress condition, and
identify aircraft position data from which an aircraft position can be derived during the occurrence of a distress condition;
configure an aircraft condition and monitoring function (ACMF) engine using the plurality of user configurable parameters from the ground-based system to apply the trigger logic to the identified aircraft sensor and/or system data and monitor for the plurality of distress conditions specified by the plurality of user configurable parameters;
execute the configured ACMF engine to detect the occurrence of a distress condition specified in the plurality of user configurable parameters;
automatically generate a data message when a distress condition occurrence has been detected, the data message including the aircraft sensor and/or system data on which the detection of the one or more trigger conditions was based and the identity of the detected distress condition; and
automatically send the data message to a transmission system onboard the aircraft that is configured to transmit a search and rescue signal;
wherein ADT functionality that is user configurable is provided on the aircraft.

2. The ADT triggering function of claim 1, wherein to execute the controller is further configured to:
apply the trigger logic specified in the user configurable parameters to the aircraft sensor and/or system data specified in the user configurable parameters; and
detect the occurrence of a distress condition identified in the plurality of user configurable parameters when the occurrence of one or more of the trigger conditions specified in the user configurable parameters is detected.

3. The ADT triggering function of claim 1, wherein the ground-based system comprises a software tool configured to build the configuration file containing the plurality of user configurable parameters and store the configuration file containing the plurality of user configurable parameters in a database.

4. The ADT triggering function of claim 1, wherein the trigger logic comprises one or more mathematical functions including one or more of arithmetic, statistical, logical, relational, assignment, changed state, signal time, or frequency transformation functions.

5. The ADT triggering function of claim 1, wherein the trigger logic is configured to be executed at one or more of the following avionics intervals 20 Hertz (Hz), 10 Hz, 5 Hz, or 1 Hz.

6. The ADT triggering function of claim 1, wherein the format of the configuration file comprises Structured Query Language (SQL), Extensible Markup Language (XML), JavaScript Object Notation (JSON), or binary format.

7. The ADT triggering function of claim 1, wherein:
the user configurable parameters further comprise an identity of a transmission system onboard the aircraft configured to transmit the search and rescue signal to a ground center, and
the ACMF engine is configured to automatically transmit the data message to the ground center using the transmission system specified in the user configurable parameters.

8. The ADT triggering function of claim 7, wherein the transmission system comprises an onboard emergency locator transmitter-Distress Tracker (ELT-DT) or a communication management unit (CMU).

9. A computer-implemented method in a modular avionics unit (MAU) processor module on an aircraft for implementing an autonomous distress tracking (ADT) triggering function, the method comprising:
receiving a configuration file containing a plurality of user configurable parameters from a ground-based system that:
identify aircraft sensor and/or system data from which a plurality of distress conditions for which to monitor can be determined,
provide trigger logic for each distress condition, the trigger logic for each distress condition identifying logic to apply to the aircraft sensor and/or system data and one or more trigger conditions for identifying the occurrence of the distress condition, and
identify aircraft position data from which an aircraft position can be derived during the occurrence of a distress condition;
configuring an aircraft condition and monitoring function (ACMF) engine using the plurality of user configurable parameters from the ground-based system to apply the trigger logic to the identified aircraft sensor and/or system data and monitoring for the plurality of distress conditions specified by the plurality of user configurable parameters;
executing the configured ACMF engine to detect the occurrence of a distress condition specified in the plurality of user configurable parameters;
automatically generating a data message when a distress condition occurrence has been detected, the data message including the aircraft sensor and/or system data on which the detection of the one or more trigger conditions was based and the identity of the detected distress condition; and
automatically sending the data message to a transmission system onboard the aircraft that is configured to transmit a search and rescue signal;
wherein ADT functionality that is user configurable is provided on the aircraft.

10. The method of claim 9, wherein executing the configured ACMF engine comprises:
applying the trigger logic specified in the user configurable parameters to the aircraft sensor and/or system data specified in the user configurable parameters; and
detecting the occurrence of a distress condition identified in the plurality of user configurable parameters when the occurrence of one or more of the trigger conditions specified in the user configurable parameters is detected.

11. The method of claim 9, wherein the ground-based system comprises a software tool configured to build the configuration file containing the plurality of user configurable parameters and store the configuration file containing the plurality of user configurable parameters in a database.

12. The method of claim 9, wherein the trigger logic comprises one or more mathematical functions including one or more of arithmetic, statistical, logical, relational, assignment, changed state, signal time, or frequency transformation functions.

13. The method of claim 9, wherein the trigger logic is configured to be executed at one or more of the following avionics intervals 20 Hertz (Hz), 10 Hz, 5 Hz, or 1 Hz.

14. The method of claim 9, wherein the format of the configuration file comprises Structured Query Language (SQL), Extensible Markup Language (XML), JavaScript Object Notation (JSON), or binary format.

15. The method of claim 9, wherein:
the user configurable parameters further comprise an identity of a transmission system onboard the aircraft that is configured to transmit the search and rescue signal to a ground center, and
automatically sending the data message comprises automatically transmitting the search and rescue signal to the ground center using the transmission system specified in the user configurable parameters.

16. The method of claim 15, wherein the transmission system comprises an onboard emergency locator transmitter-Distress Tracker (ELT-DT) or a communication management unit (CMU).

17. A non-transitory computer-readable medium having stored thereon instructions that when executed by a processor on an aircraft cause the processor to perform a method for implementing an autonomous distress tracking (ADT) triggering function, the method comprising:
receiving a configuration file containing a plurality of user configurable parameters from a ground-based system that:
identify aircraft sensor and/or system data from which a plurality of distress conditions for which to monitor can be determined,
provide trigger logic for each distress condition, the trigger logic for each distress condition identifying logic to apply to the aircraft sensor and/or system data and one or more trigger conditions for identifying the occurrence of the distress condition, and
identify aircraft position data from which an aircraft position can be derived during the occurrence of a distress condition;
configuring an aircraft condition and monitoring function (ACMF) engine using the plurality of user configurable parameters from the ground-based system to apply the trigger logic to the identified aircraft sensor and/or system data and monitor for the plurality of distress conditions specified by the plurality of user configurable parameters;
executing the configured ACMF engine to detect the occurrence of a distress condition specified in the plurality of user configurable parameters;
automatically generating a data message when a distress condition occurrence has been detected, the data message including the aircraft sensor and/or system data on which the detection of the one or more trigger conditions was based and the identity of the detected distress condition; and
automatically sending the data message to a transmission system onboard the aircraft that is configured to transmit a search and rescue signal;
wherein ADT functionality that is user configurable is provided on the aircraft.

18. The non-transitory computer-readable medium of claim 17, wherein executing the configured ACMF engine comprises:
applying the trigger logic specified in the user configurable parameters to the aircraft sensor and/or system data specified in the user configurable parameters; and
detecting the occurrence of a distress condition identified in the plurality of user configurable parameters when the occurrence of one or more of the trigger conditions specified in the user configurable parameters is detected.

19. The non-transitory computer-readable medium of claim 17, wherein the trigger logic comprises one or more mathematical functions including one or more of arithmetic, statistical, logical, relational, assignment, changed state, signal time, or frequency transformation functions.

20. The non-transitory computer-readable medium of claim 17, wherein:
the user configurable parameters further comprise an identity of a transmission system onboard the aircraft that is configured to transmit the search and rescue signal to a ground center, and
automatically sending the data message comprises automatically transmitting the search and rescue signal to the ground center using the transmission system specified in the user configurable parameters.
